(19) United States
(12) Patent Application Publication
(10) Pub. No.: US 2019/0210688 A1
(43) Pub. Date: Jul. 11, 2019

(54) Bicycle Handlebar

(71) Applicant: Canyon Bicycles GmbH, Koblenz (DE)

(72) Inventors: Lars Wagner, Muehltal (DE); Wolfgang Kohl, Schwabach (DE); Lukas Schuchnigg, Koblenz (DE)

(21) Appl. No.: 16/243,288

(22) Filed: Jan. 9, 2019

(30) Foreign Application Priority Data
Jan. 11, 2018 (DE) 20 2018 000 134.1

(51) Int. Cl. B62K 21/16

(52) U.S. Cl. CPC B62K 21/16

(57) ABSTRACT

A bicycle handlebar includes a central part for connection with a handlebar stem or formed integrally with the same. Two outer parts are detachably connected with the central part such that they are variable in their position. The width of the handlebar can be adjusted individually.

### CROSS-REFERENCE TO RELATED APPLICATION

This application claims priority to German Utility Model Application No. 20 2018 000 134.1 filed Jan. 11, 2018, the disclosure of which is hereby incorporated in its entirety by reference.

### BACKGROUND OF THE INVENTION

### Field of the Invention

The disclosure relates to a bicycle handlebar.

### Description of Related Art

A variety of different handlebar shapes exists for different types of bicycles. In addition, these handlebar shapes each differ in width so as to be suitable for a corresponding user. Besides anatomic conditions of the user, the width of a bicycle handlebar is also subject to individual requirements made by the users. With handlebars for mountain bikes, for example, whose outer portions are straight in shape, it is possible to reduce the width of the handlebar by cutting the outer portions, i.e. by sawing them off. However, it is not possible to vary the width of such handlebars or to try e.g. a smaller handlebar width and to widen it again, if so desired. With other handlebar shapes, e.g. with racing bicycle handlebars, handlebars curved opposite to the traveling direction and the like, it is not possible to cut the handlebar so as to change the width of the handlebar.

### SUMMARY OF THE INVENTION

It is an object of the disclosure to provide a bicycle handlebar with which the width of a handlebar can be varied in a simple manner.

The object is solved, according to the invention, with a bicycle handlebar having the features of the present disclosure.

The bicycle handlebar of the present disclosure includes a central part. The central part is adapted to be connected with the handlebar stem using a clamping connection. Likewise, it is possible for the central part of the handlebar to be integrally connected with the stem. Two outer parts are connected with the central part that is arranged or formed in particular symmetrically with respect to the handlebar stem. In the mounted state, the outer parts are thus arranged on the outer side of the central part. The outer parts each include a gripping portion. According to the disclosure, the two outer parts are detachably connected with the central part. Thereby, it is possible e.g. to connect the outer parts in different positions with the central part so that the handlebar width can be varied. Further, it is possible to connect different outer parts with the central part so that the width of the handlebar, but also the shape of the handlebar can be varied.

In a particularly preferred embodiment the position of the outer parts may be changed relative to the central part. For example, it is possible to connect the outer parts with the central part in different positions. Here, the connection may be made by means of clamping elements and/or locking elements and/or other fixing elements.

In a particularly preferred embodiment the outer parts are displaceable with respect to the central part. Specifically, a continuous displacement and a subsequent fixation of the outer parts on the central part are possible, so that a continuous variation of the handlebar width can be realized.

Preferably, fixing elements are provided for the fixation of the outer parts on the central part. The fixing elements may be locking elements and/or clamping elements. Specifically, screws such as headless screws are preferred as fixing elements, wherein, in a preferred embodiment, only one headless screw is respectively provided for fixing a respective one of the two outer parts. In a particularly simple manner it is possible to change the position of the outer part by simply loosening the screw and to then fix it again by tightening the screw. In this preferred embodiment a change in handlebar width is thus possible in a simple manner.

For the connection of the outer parts with the central part it is particularly preferred that the central part and/or the outer parts include an opening. If, for example, the central part has an opening in both its outer sides, the two outer parts can be inserted into the corresponding opening, respectively. Here, it is particularly preferred that the inner dimensions of the opening correspond to the outer dimensions of the outer part with little tolerance, if any. It is also possible that the outer parts have an opening so that the outer parts are pushed over the outer ends of the central part, with the dimensions again having little tolerances, if any. Likewise, it is possible that e.g. both the outer part and the central part include an in particular pin-shaped protrusion which may be inserted into the opening of the respective other part. Providing an opening in the central part and/or the outer parts has the particular advantage that the force transmission between the outer parts and the central part is good. The reason for this is in particular that an overlap of the two parts can be realized. Further, it is an advantage of such a design that it is possible in particular to arrange the parts in a step-free manner with respect to each other, so that a very individual adjustment of the handlebar width can be realized.

In another preferred embodiment of the bicycle handlebar of the present disclosure, the central part and/or the outer parts have at least one outlet opening. The outlet opening serves to pass cables therethrough. Thus, it is possible to lead e.g. cables of gear shift levers into the handlebar interior and then through the stem into the steer tube and thereafter into frame tubes, if so provided. Here, it is particularly preferred that the outlet opening is formed as a slot provided in each of the two outer parts and open to the central part. This is advantageous in that the outer parts can be displaced in a simple manner with respect to the central part. It is even possible to pull the outer part completely out of the central part e.g. to be able to transport the bicycle in a simple manner. Here, no disassembly of the cables is required. Likewise, it is of course possible that the corresponding slot is provided in the central part and is then open to the outer side towards the outer part.

It is preferred that the slot is provided in a side of the outer parts and/or the central part that is the lower side in the mounted state. In particular this is advantageous in that the forces transferred from the outer parts to the central part can be transferred better, since preferably no openings or recesses influencing the force transmission are provided in the side of the outer parts and the central part that is the upper side in the mounted state.

The outer parts preferably include an inner connecting portion directed towards the central part, which serves for connection with the central part. In the connected state at least a part of the connecting portion is arranged inside the central part and/or surrounds the central part, so that a reliable force transmission is guaranteed. Further, the outer parts each include an outer gripping portion, i.e. a portion directed away from the central part. Here, the gripping part may be straight in shape and serve to receive bicycle handles. The bicycle handles are arranged on the gripping portions in particular by plugging.

The gripping also be of a curved or bent design in particular to realize a racing bicycle handlebar.

### BRIEF DESCRIPTION OF THE DRAWINGS

The disclosure will be explained hereinafter in more detail with reference to a preferred embodiment and to the accompanying drawings.

In the Figures:

FIG. 1 is a schematic top plan view of a bicycle handlebar of the present disclosure in the mounted state,

FIG. 2 is a schematic bottom view of a part of the bicycle handlebar illustrated in FIG. 1 in the disassembled state, and

FIG. 3 is a schematic sectional view along line III-III in FIG. 2.

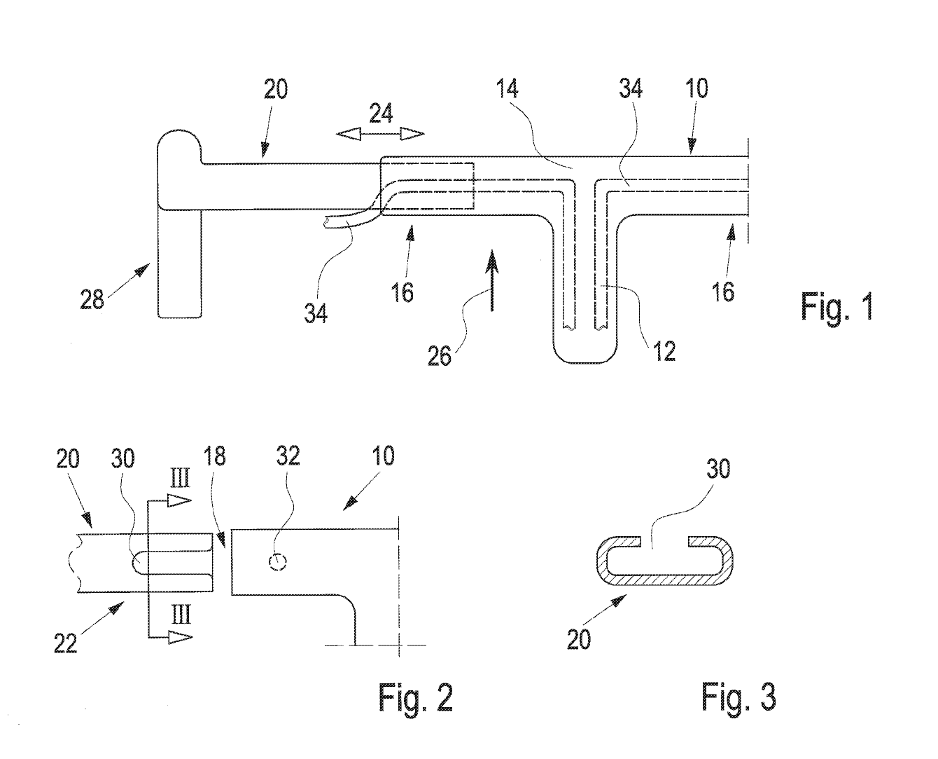

### DESCRIPTION OF THE INVENTION

The bicycle handlebar illustrated in the Figures is a racing bicycle handlebar. According to the disclosure, however, other handlebar shapes are also possible.

The bicycle handlebar of the present disclosure includes a central part 10 which in the embodiment illustrated is integrally connected or formed with a handlebar stem 12. The central part 10 includes an in particular hollow element 14 extending substantially orthogonally with respect to the handlebar stem. In the embodiment illustrated the tubular element of the central part 10 has a respective opening 18 (FIG. 2) in end portions 16. One outer part 20 is respectively inserted in the opening 18 on both sides. Here, an end portion 22 of an outer part 20 has an outer contour that substantially corresponds to the inner contour of the portion 16 of the central part 10. Thereby, it is possible to displace the outer parts 20 in the direction of an arrow 24, i.e. transversely to traveling direction 26 in the mounted state. Thus, the width of the handlebar can be varied.

The outer part 20, which in the embodiment illustrated is an outer part with a curved gripping portion 28 for forming a racing bicycle handlebar, may also have another, straight design e.g. for forming a mountain bike handlebar. If the design is that of a mountain bike handlebar, the gripping portion 28 is straight in shape and serves in particular for plugging a bicycle handle thereon.

The outer parts 20 are formed, in particular, to be tubular, i.e. hollow throughout, preferably at least in the portion 22. The portions 22 of the outer parts, which are inserted into the openings 19 of the central portion 10, include slot 30 extending in the longitudinal direction of the outer parts. The slot 30 is open to the central part 10.

For fixing, the outer part 20 is inserted into the opening 18 in FIG. 2 from the left side. When the desired width is reached, the corresponding outer part 20 is fixed in the central part 10. This is done using a fixing element which in the embodiment illustrated is a headless screw 32. The embodiment illustrated in the Figures allows for a continuous displacement of the outer parts 20 in the direction of the arrow 24. Further, due to a slot 30 being provided, it is possible to introduce cables 34 into the interior of the central part 10. In the embodiment illustrated the cables 34 are then introduced into the stem 12 which is also hollow. From there, via the steer tube, they arrive e.g. at a front brake or are guided in frame elements to a rear brake or a gearshift.

Due to the provision of a slot open to the central part 10, it is possible, even with the cables 34 mounted, to pull the outer parts 20 completely out of the central part 10 without having to detach the cables. Thereby it is possible, e.g. for transport purposes, to extremely reduce the handlebar width by pulling out the two outer parts 20.

While several aspects of the present disclosure are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The disclosure described above is defined by the appended claims and all changes to the invention that fall within the meaning and range of equivalency of the claims are to be embraced within their scope.

1. A bicycle handlebar comprising:
a central part for connection with a handlebar stem or formed integrally with the same, and
two outer parts detachably connected with the central part, the outer parts comprising gripping portions.

2. The bicycle handlebar of claim 1, wherein a position of the outer parts is variable with respect to the central part for adjusting a handlebar width.

3. The bicycle handlebar of claim 1, wherein the outer parts are displaceable with respect to the central part for adjusting a handlebar width.

4. The bicycle handlebar of claim 1, further comprising a fixing element for fixing the outer parts to the central part.

5. The bicycle handlebar of claim 4, wherein the fixing element is formed as a clamping element.

6. The bicycle handlebar of claim 1, wherein at least one of the central part and the outer parts comprise an opening for the insertion of the outer parts or the central part, respectively.

7. The bicycle handlebar of claim 1, wherein at least one of the central part and the outer parts comprise at least one outlet opening for passing cables therethrough.

8. The bicycle handlebar of claim 7, wherein the outlet opening is formed as a slot provided in the outer parts and open to the central part.

9. The bicycle handlebar of claim 1, wherein the outer parts comprise an inner connecting portion directed towards the central part for connection with the central part, and a gripping portion provided on an opposing side.

10. The bicycle handlebar of claim 9, wherein the gripping portion is curved so as to form a racing bicycle handlebar.

11. The bicycle handlebar of claim 9, wherein the gripping portion is formed substantially straight for the purpose of plugging the bicycle handle thereon.
